(19) United States
(12) Patent Application Publication
(10) Pub. No.: US 2011/0298370 A1
(43) Pub. Date: Dec. 8, 2011

(54) Extra-high pressure mercury lamp and method of manufacturing extra-high pressure mercury lamp of the same

(75) Inventor: Hirohisa Iwabayashi, Hyogo (JP)

(73) Assignee: USHIO DENKI KABUSHIKI KAISHA, Tokyo (JP)

(21) Appl. No.: 13/067,355

(22) Filed: May 26, 2011

(30) Foreign Application Priority Data
Jun. 3, 2010 (JP) 2010-127812

(51) Int. Cl. H01J 61/20; H01J 9/24

(52) U.S. Cl. 313/639; 445/23

(57) ABSTRACT

A lighting mode of an extra-high pressure mercury lamp can be switched between a steady lighting mode and a low electric power lighting mode. A temperature maintaining portion that absorbs light emitted from a light emission section is provided in a vicinity of a boundary between a sealing portion and a light emission section in an outer circumference direction of the lamp. The temperature maintaining portion is made of a material having thermal expansion coefficient that is greater than a material that forms the light emission section. The temperature maintaining portion comes in contact with the light emission section in the low electric power lighting mode. In the steady lighting mode, a gap is formed between the temperature maintaining portion and the light emission section so that the temperature maintaining portion is separated from the light emission section.

### CROSS-REFERENCES TO RELATED APPLICATION

This application claims priority from Japanese Patent Application Serial No. 2010-127812 filed Jun. 3, 2010, the contents of which are incorporated herein by reference in their entirety.

### TECHNICAL FIELD

The present invention relates to an extra-high pressure mercury lamp, and in particular, a method for manufacturing an extra-high pressure mercury lamp or an extra-high voltage discharge lamp, used for back light of a liquid crystal display apparatus or a projection type projector apparatus, such as a DLP (Digital Light Processor—Registered Trademark) using a DMD (Digital Mirror Device—Registered Trademark).

### BACKGROUND

In recent years, it is required that electric power supplied to a projector apparatus varies if needed. For example, when an image is projected on a screen at a meeting, it is required to increase the intensity of light emitted from the projector apparatus to clearly project the image on a screen. On the other hand, it is desirable to decrease the intensity of light emitted from the projector apparatus, when it is unnecessary to project an image on the screen. For example, when participants make discussion in a meeting, since projection of an image to the screen may be temporarily interrupted, it is desirable to decrease the intensity of light from the projector apparatus to save power consumption at the time of interruption. In this case, it is not desirable to turn off the light source by stopping supplying electric power to the light source built in the projector apparatus. This is because once such a light source goes out, it takes long time to re-light the lamp. Therefore, in the projector apparatus, it is desirable to switch between a steady lighting mode (lighting performed with rated power) and a low electric power lighting mode (lighting performed with electric power lower than the rated power) if needed.

Japanese Patent Application Publication No. 2009-527871 discloses a method of impressing alternating current voltage to a discharge lamp, thereby driving the discharge lamp. In this drive method, a first operational mode and a second operational mode are provided, wherein electric power supplied to the discharge lamp in the second operational mode is set to be smaller than that in the first operational mode.

In general, to increase radiance of an extra-high pressure mercury lamp, high density mercury of 0.15 mg/mm³ or more is enclosed in the light emission section, which is used as a light source of a projector apparatus. The radiance of such a lamp is proportional to the mercury vapor pressure in a light emission section, and it decreases as the mercury vapor pressure in a light emission section becomes low. The mercury vapor pressure of the light emission section mainly depends on the temperature of the light emission section. That is, as the light emission section is low in temperature, the mercury is more unevaporated in the light emission space so that the mercury vapor pressure decreases. Therefore, there is a problem set forth below. The resistance between a pair of electrodes decreases as the mercury vapor pressure decreases, so that current becomes easy to flow between the electrodes. Therefore, since electrons frequently collide with the electrodes thereby causing sputtering of the electrodes, structure material of the electrode is scattered in the electrical discharge space and adheres to the pipe wall of the light emission section, thereby causing blackening of the light emission section.

In the drive method of the discharge lamp described in Japanese Patent Application Publication No. 2009-527871, since the light emission section of the discharge lamp becomes low in temperature when electric power supplied to the discharge lamp in the second operational mode is made smaller than that of the first operational mode, it is impossible to avoided the mercury from becoming unevaporated in the light emission space. Thus, the above-mentioned problem occurs. And even though this problem is referenced, a solution is not offered in Japanese Patent Application Publication No. 2009 527871.

### SUMMARY

It is an object of the described to offer an extra-high pressure mercury lamp and a method for manufacturing an extra-high pressure mercury lamp, which can inhibit a light emission section and a sealing portion including an electrode axis portion of the discharge lamp, from becoming low in temperature when a lighting mode is changed from a steady lighting mode to a low electric power lighting mode in order to save electric power supplied to a discharge lamp.

Thus, the above-mentioned problems are solved by means set forth below.

A lighting mode of an extra-high pressure mercury lamp can be switched between a steady lighting mode and a low electric power lighting mode. A temperature maintaining portion that absorbs light emitted from a light emission section is provided in a vicinity of a boundary between a sealing portion and a light emission section in an outer circumference direction of the lamp. The temperature maintaining portion is made of a material having thermal expansion coefficient that is greater than a material that forms the light emission section. The temperature maintaining portion comes in contact with the light emission section in the low electric power lighting mode. In the steady lighting mode, a gap is formed between the temperature maintaining portion and the light emission section so that the temperature maintaining portion is separated from the light emission section.

A light emission section may enclose 0.15 mg/mm³ or more of mercury. A sealing portion may continuously be formed from the light emission section. The lamp may be driven in the low electric power lighting mode at an electric power in a range of 20% to 75% of rated consumed power than in the steady electric power lighting mode. The temperature maintaining portion for maintaining the temperature of the light emission section absorbs light emitted from the light emission section. The temperature maintaining portion is provided in a vicinity of a boundary between the sealing portion and the light emission section in an outer circumference direction of the lamp. The temperature maintaining portion may be made of a material that has a thermal expansion coefficient that is greater than a material that forms the light emission section. During the steady lighting mode, the temperature maintaining portion is separated from the light emission section so as to form the gap between the temperature maintaining portion and the light emission section. In contrast, during the low electric power lighting mode the temperature maintaining portion comes in contact with the light emission section.

Further, the temperature maintaining portion may be in shape of a film that has a thickness of 0.2-1 mm.

Furthermore, the temperature maintaining portion may be cylindrical.

In addition, the thermal expansion coefficient of the temperature maintaining portion may be 1×10⁻⁶/K or more.

According to a method for manufacturing the extra-high pressure mercury lamp, a temperature maintaining portion formation medium is applied on a gap formation medium. Then the gap formation medium and the temperature maintaining portion formation medium are primarily dried so as to remove solvent contained in the gap formation medium and the temperature maintaining portion formation medium. The gap formation medium and the temperature maintaining portion formation medium are secondarily dried so as to remove the gap formation medium and to form the temperature maintaining portion.

Further, the gap formation medium may be a gelatinous substance obtained by mixing C₁₇H₃₅COOH (stearic acid) with graphite powder.

Furthermore, the temperature maintaining portion formation medium may be a suspension obtained by mixing powders of alumina (Al₂O₃), magnesium oxide (MgO), silica (SiO₂), and sodium oxide (Na₂O) with water.

In addition, the temperature maintaining portion formation medium may be a metal alkoxide polymer of alumina (Al₂O₃), magnesium oxide (MgO), silica (SiO₂), and sodium oxide (Na₂O).

### BRIEF DESCRIPTION OF THE DRAWINGS

Other features and advantages of the present extra-high pressure mercury lamp and the present method of manufacturing an extra-high pressure mercury lamp will be apparent from the ensuing description, taken in conjunction with the accompanying drawings, in which:

FIG. 1 is a plan view of the structure of an extra-high pressure mercury lamp according to an embodiment;

FIG. 2 is an enlarged cross sectional view of part of a light emission section and one of sealing portions of an extra-high voltage discharge lamp shown in FIG. 1, at time of a steady lighting mode;

FIG. 3A is a cross sectional view at time of a low electric power lighting mode, taken along the line of FIG. 1 in a diameter direction;

FIG. 3B is a cross sectional view at time of a steady lighting mode, taken along the line of FIG. 1 in diameter direction;

FIG. 4 is a diagram showing an example of forming a temperature maintaining portions 5 along part of a light emission section 2 and an outer surface of sealing portions 3 and 3, which are continuously formed from the light emission section 2;

FIG. 5 is a plan view of the structure of an extra-high pressure mercury lamp according to another embodiment;

FIG. 6 is an enlarged cross sectional view of part of a light emission section and one of sealing portions of an extra-high voltage discharge lamp shown in FIG. 5, at time of a steady lighting mode; and

FIG. 7 shows a configuration example of a lighting apparatus to which an extra-high pressure mercury lamp is applied.

### DESCRIPTION

According to the above, the light emission section and the sealing portions including the electrode axis portions are kept warm at time of a low electric power lighting mode, so that the temperature of the light emission section and the sealing portions including the electrode axis portions is prevented from dropping, whereby the mercury vapor pressure in the interior space of the light emission section is prevented from dropping, so that a load to the electrodes can be reduced thereby preventing blackening of the pipe wall of the light emission section.

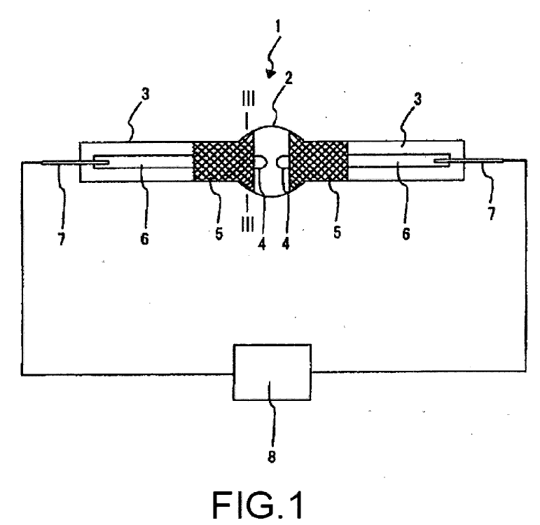

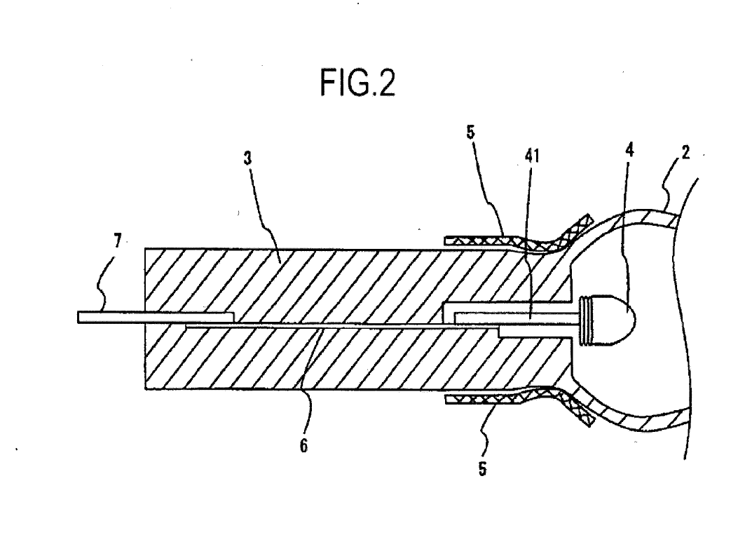

Description of a first embodiment will be given below, referring to FIGS. 1, 2, 3 and 4. FIG. 1 is a plan view of the structure of an extra-high pressure mercury lamp according to the embodiment, and FIG. 2 is an enlarged cross sectional view of part of a light emission section and one of sealing portions of the extra-high voltage discharge lamp shown in FIG. 1 at time of a steady lighting mode. As shown in these figures, the extra-high pressure mercury lamp has a quartz glass arc tube, which is made up of a spherical light emission section 2 and a pair of sealing portions 3 that are continuously formed from the respective ends of the light emission section 2. In the interior space of the light emission section 2, a pair of electrodes 4 and 4 made of tungsten is arranged so that the respective tips of the electrodes may face each other. Moreover, while 0.15 mg/mm³ or more of mercury is enclosed in the interior space of the light emission section 2, so that the mercury vapor pressure becomes 150 atmospheres or more when the lamp is lighted in a steady lighting mode. A predetermined amount of rare gas is also enclosed therein. Temperature maintaining portions 5 and 5 for maintaining the temperature of the light emission section 2 and electrode axis portions 41 by absorbing light emitted from the light emission section 2 of the extra-high pressure mercury lamp 1, are formed to cover areas of parts of an outer circumferential surface of the sealing portions 3 and 3, which are on the respective sides of the light emission section 2, and parts of the light emission section 2 that are continuously formed from the respective sealing sections 3 (each of which is hereinafter referred to as a vicinity of a boundary between the sealing portion and the light emission section). The extra-high voltage discharge lamp 1 is turned on by a lighting device 8.

A metallic foil 6 made of molybdenum is buried in each of the airtightly sealed sealing portions 3. While one end of each metallic foil 6 is connected to an end portion of the electrode axis portion 41, which is connected to the electrode 4, the other end portion of the metallic foil 6 is connected to an external lead 7. The external lead 7 is projected outward from each sealing portion 3.

Mercury of 0.15 mg/mm³ or more is enclosed in the lamp to obtain radiation light of a required visible light wavelength, for example, 380-780 nm. Although the amount of mercury to be enclosed differs depending on the temperature conditions, such an amount of mercury is enclosed to obtain an extremely high steam pressure, such as 15 MPa or more, at time of lighting. A discharge lamp, whose mercury vapor pressure is high, such as 20 MPa or more or 30 MPa or more at time of lighting, can be made by further increasing the amount of the enclosed mercury. That is, a light source suitable for a projector apparatus can be realized if the mercury vapor pressure is made high.

Rare gas, whose amount is approximately 10 kPa to kPa in static pressure, is enclosed in the lamp. Specifically, the rare gas may be argon gas, as argon gas may improve lighting starting nature of the lamp. Moreover, iodine, bromine, chlorine, and the like are enclosed as halogen, and the enclosed amount of halogen is selected from a range of 10⁻⁶ to 10⁻² μmol/mm³. Although a function of the halogen is to extend a life span (prevention of blackening) by using the halogen cycle, there is also a function of preventing devitrification of the light emission section 2, in the case where the discharge lamp is very small and the inner pressure is very high, as in the extra-high pressure mercury lamp of the present invention.

In the extra-high pressure mercury lamp according to the described, when the lamp is changed from a steady lighting mode to a low electric power lighting mode to save electric power supplied to the discharge lamp, the light emission section 2 is kept warm, so that the light emission section 2 is prevented from becoming low in temperature, and furthermore the mercury vapor pressure in the light emission section 2 is prevented from decreasing. For this reason, the temperature maintaining portions 5, which absorb the light emitted from the light emission section 2, are formed on the outer surfaces near the boundaries between the light emission section 2 and the sealing portions 3 of the extra-high pressure mercury lamp.

To certainly keep the light emission section warm, the temperature maintaining portions 5 need to be provided at least near the respective boundaries between the light emission section 2 and the sealing portions 3 and 3. As shown in FIG. 1, the temperature maintaining portions 5 are formed to cover from parts of the light emission section 2 up to parts of the outer surfaces of the sealing portions 3 and 3, which are continuously formed therefrom respectively. However, the temperature maintaining portions 5 are desirably formed to not interfere with light emitted from the light emission section 2.

Although the temperature maintaining portions 5 serve to keep the light emission section 2 warm, to prevent the light emission section 2 from becoming low in temperature at time of a low electric power lighting mode, it is desirable that the temperature maintaining portions 5 be provided to be distant from the light emission section 2 so that the temperature of the light emission section 2 is not kept in a steady lighting mode, which will prevent the light emission section 2 from becoming excessively high in temperature.

For such a reason, it is not only necessary to form minute gaps between the temperature maintaining portions 5 and the light emission section 2 so that the temperature maintaining portions 5 may be apart from the light emission section 2 at time of the steady lighting mode, but also to form the temperature maintaining portions 5 to be brought into contact with the light emission sections 2 at time of the low electric power lighting mode. The temperature maintaining portions 5 are made from members that can expand and contract according to the temperature of the temperature maintaining portions themselves. That is, when the temperature maintaining portions 5 are high in temperature, they are apart from the light emission section 2 due to thermal expansion so that minute gaps are respectively formed between the light emission section 2 and the temperature maintaining portions 5. On the other hand, when the temperature maintaining portions 5 are low in temperature, they contract to come in contact with the light emission section 2, whereby the light emission section 2 is kept warm.

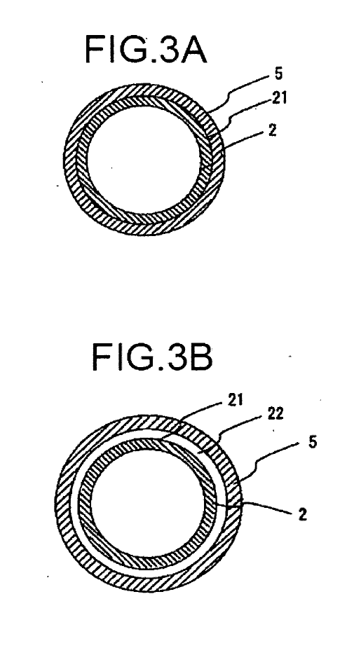

FIG. 3A is a cross sectional view of the extra-high pressure mercury lamp in a low electric power lighting mode, taken along a line A-A of FIG. 1 in a diameter direction. FIG. 3B is a cross sectional view of the extra-high pressure mercury lamp in the steady lighting mode, taken along the line A-A of FIG. 1 in the diameter direction. Electrodes are omitted from these figures. FIG. 3A shows a state of the temperature maintaining portions 5 where the light emission section 2 is low in temperature at time of the low electric power lighting mode, and FIG. 3B shows a state of the temperature maintaining portions 5 where the light emission section 2 is high in temperature at time of the steady lighting mode. As shown in FIG. 3A, since the temperature maintaining portions 5 are low in temperature at the time of the low electric power lighting mode, the temperature maintaining portions 5 come in contact with the outer surface 21 of the light emission section 2 so that the light emission section 2 is kept warm. On the other hand, as shown in FIG. 3B, since the temperature maintaining portions 5 are high in temperature at the time of the steady lighting mode, the temperature maintaining portions 5 are apart from the outer surface 21 of the light emission section 2 so that minute gaps are formed between the outer surface 21 of the light emission sections 2 and the temperature maintaining portions 5, whereby the light emission section 2 is prevented from becoming extremely high in temperature.

In order that the temperature maintaining portions are made expandable and contractible in the diameter direction of the light emission section 2, the temperature maintaining portions 5 are formed in the shape of a film and are made of material whose thermal expansion coefficient is higher than quartz glass (SiO₂), which forms the light emission section 2, for example, at least one or more selected from a group of alumina (Al₂O₃), magnesium oxide (MgO), zirconium oxide (ZrO₂), and silica (SiO₂). The coefficient of thermal expansion for Al₂O₃ is 7×10⁻⁶/K, for MgO is 11×10⁻⁶/K, for ZrO₂ is 1×10⁻⁵/K, and for SiO₂ is 5×10⁻⁷/K. In addition, to easily bring the temperature maintaining portions 5 in contact with the quartz glass of the light emission section 2, preferably, the temperature maintaining portions 5 include a predetermined amount of sodium oxide (Na₂O). The thickness of the temperature maintaining portions 5 is 0.2-1 mm. When the thickness of the temperature maintaining portions 5 is set to fall within this range, the temperature maintaining portions 5 become easy to expand and contract, whereby while the temperature maintaining portions 5 are easily separated from the light emission section 2 due to thermal expansion at time of the steady lighting mode so that minute gaps are respectively formed therebetween, the temperature maintaining portions 5 contract at time of the low electric power lighting mode so that the temperature maintaining portions 5 respectively come in contact with the light emission section 2.

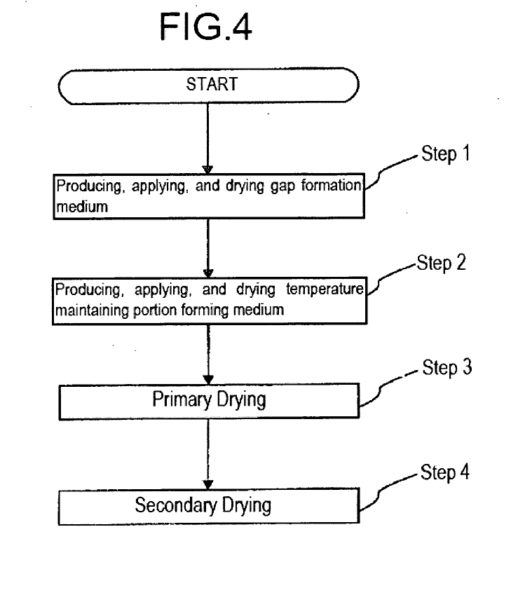

Next, an example of a process, in which the temperature maintaining portions 5 are formed from parts of the light emission section 2 up to the outer surfaces of the sealing portions 3, which are continuously formed from the light emission section 2, will be described below, referring to FIG. 4.

Step 1: Producing, Applying, and Drying Gap Formation Medium.

Stearic acid (C₁₇H₃₅COOH) is mixed with graphite powder to produce gelled gap formation medium. The produced gap formation medium is applied to the outer circumferential surfaces, near boundaries between the sealing portions 3 and the light emission section 2, using a brush, and then is sufficiently dried. The gap formation medium may be applied to the outer circumferential surfaces near the boundaries by spraying, dipping, or the like.

Step 2: Producing, Applying, and Drying Temperature Maintaining Portion Formation Medium.

After applying and drying the gap formation medium in the Step 1, turbid liquid whose main ingredient is alumina (Al₂O₃) is produced by mixing powder containing a small amount of magnesium oxide (MgO), zirconium oxides (ZrO₂), and silica (SiO₂) with water. The produced turbid liquid is applied on the gap formation medium by using a brush, and then is sufficiently dried, whereby the temperature maintaining portion formation medium is produced. The temperature maintaining portion formation medium may be applied to the light emission section 2 by spraying, dipping, or the like.

Step 3: Primary Drying.

An arc tube 1 having the light emission section 2, in which the temperature maintaining portion formation medium is formed on the gap formation medium, is put in an electric furnace, so as to heat it at 100 degree Celsius, thereby evaporating stearic acid contained in the gap formation medium.

Step 4: Secondary Drying.

After the primary drying of the arc tube 1 is finished, the arc tube is put in the electric furnace so as to heat it for 30 minutes at 1,000 degree Celsius, thereby calcinating the applied alumina. At this time, graphite, which is applied thereto in the Step 1, is burned as CO or CO2, and a gap, which is equivalent to the thickness of the gap formation medium, is formed between the temperature maintaining portions 5 and the light emission section 2.

In addition, in Step 2, the temperature maintaining portion formation medium may be applied not only by the method of using turbid liquid but also by a sol-gel method using a metal alkoxide polymer. In the case where a sol-gel method is used in Step 2, alumina (Al₂O₃) is used as a main ingredient, and a colloidal (sol) solution is obtained by hydrolyzing and condensation-polymerizing the metal alkoxide containing magnesium oxide (MgO), zirconium oxide (ZrO₂) and silica (SiO₂). Further, this metal alkoxide polymer is applied to the gap formation medium using a brush, and it is dried by heat so as to turn into a gel. When the sol-gel method is used in the Step 2, since ethyl alcohol evaporates at low temperature compared with the case where turbid liquid is used in the Step 2, the temperature required to calcinate alumina in the Step 4 can be reduced to approximately 200 degrees Celsius, whereby the temperature maintaining portions 5 can be easily produced.

When the above-mentioned Steps 1-4 are performed in order, since the gap formation medium formed in the predetermined area of the light emission section 2 in the Step 1 is evaporated, each of the temperature maintaining portions 5 can be formed in a vicinity of boundary between the sealing portion 3 and 3 and the light emission section 2 on the outer circumferential surface. When the temperature maintaining portions 5 become high in temperature at time of a steady lighting mode, so that it expands in a diameter outside direction of the light emission section 2, the temperature maintaining portions 5 are separated from the light emission section 2 so that minute gaps are respectively formed between the light emission section 2 and the temperature maintaining portions 5. On the other hand, when the temperature maintaining portions 5 become low in temperature at time of a low electric power lighting mode, they contract in a diameter inside direction of the light emission section 2 so that the temperature maintaining portions 5 respectively come in contact with the light emission section 2. The minute gaps formed between the temperature maintaining portions 5 and the light emission section 2 at the time of the steady lighting mode are approximately 0.01 mm-0.5 mm in size.

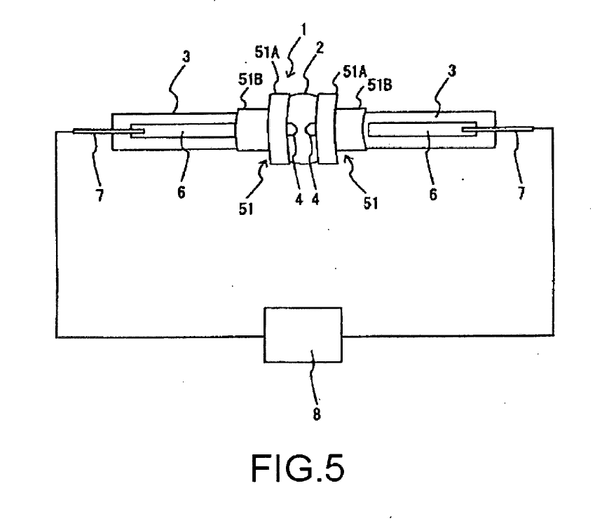

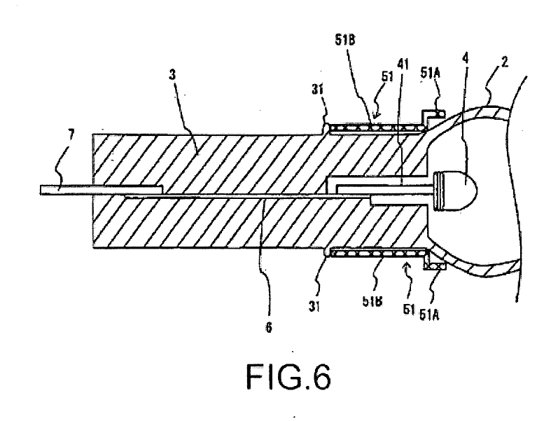

Description of a second embodiment will be given below, referring to FIGS. 5 and 6. FIG. 5 is a plan view of the structure of the extra-high pressure mercury lamp, and FIG. 6 is an enlarged cross sectional view of part of a light emission section and one of sealing portions of the extra-high voltage discharge lamp shown in FIG. 5 at time of a steady lighting mode. In addition, in the second embodiment, the structure is approximately the same as that of the first embodiment shown in the FIGS. 1 and 2, except for temperature maintaining portions. Therefore, description of structural elements other than the temperature maintaining portions will be omitted below. As shown in these figures, the temperature maintaining portions formed on the outer circumferential surface near the boundaries between the light emission section and the sealing portions of the extra-high voltage discharge lamp are not limited to the temperature maintaining portions shown in FIG. 1, each of which is in the shape of a film. That is, as shown in FIG. 5, the temperature maintaining portions 51 are made of material, for example, alumina, whose thermal expansion coefficient is greater than that of quarts glass, which forms the light emission section 2, and are formed in cylindrical shape having inner diameters, which are different from each other. Each of the temperature maintaining portions 51 includes a large diameter cylindrical portion 51A, which surrounds the outer circumference of an end area of the light emission section 2, and a small diameter cylindrical portion 51B, which surrounds an end area of the sealing portion 3 continuously formed from the light emission section 2. Such temperature maintaining portions 51 may be formed by, for example, molding alumina powder into a cylindrical shape having different inner diameters, and then by sintering the molded cylindrical alumina at predetermined temperature for predetermined time.

The inner diameter of each of the large diameter cylindrical portions 51A is slightly larger than the outside diameter of the light emission section 2, and the inner diameter of each of the small diameter cylindrical portions 51B is slightly larger than the outer diameter of the sealing portion 3. The large diameter cylindrical portion 51A and the small diameter cylindrical portion 51B are provided so that minute gaps of approximately 0.001 mm-0.5 mm are formed between the outer surface of the large diameter cylindrical portion 51A and the light emission section 2, and between the surface of the small diameter cylindrical portion 51B and the sealing portion 3, respectively. Such a cylindrical temperature maintaining portion 51 is inserted towards the light emission section 2 from an outer end portion of each of the sealing portions 3, so that part of the light emission section 2 and part of sealing portion 3 are surrounded. In addition, although the temperature maintaining portions 51 are inserted in such a manner, since a convex portion 31 is formed on the outer surface of each sealing portion 3, there is no possibility that the temperature maintaining portions 51 come off in the respective outer end directions of the sealing portion 3.

As described above, in the extra-high pressure mercury lamp according to the present invention shown as the first and second embodiments, the temperature maintaining portions 5 or 51 become low in temperature, thereby contracting inward in the diameter direction of the light emission section 2, so that the temperature maintaining portions 5 or 51 come in contact with the outer surfaces of the light emission section 2. Thus, the light emission section 2 can be kept warm. That is, since electric power supplied to the extra-high pressure mercury lamp is reduced at the time of a low electric power lighting mode, the light emission section 2 tends to become low in temperature. However, since the temperature maintaining portions 5 or 51 come in contact with the light emission section 2, the light emission section 2 is prevented from becoming low in temperature. Therefore, in the extra-high pressure mercury lamp, since the amount of unevaporated mercury is reduced even at the time of the low electric power lighting mode, the mercury vapor pressure in the light emission section 2 and the sealing portion 3 become sufficiently high. Therefore, the resistance between a pair of electrodes 4, which are arranged so as to face each other in the interior space of the light emission section 2, does not decrease. Thus, large current does not flow through the pair of electrodes 4, a thermal load to the electrodes 4 is reduced, and the electrode structure material is prevented from evaporating from surfaces of the electrodes 4 and from being scattered therefrom, so that it is certainly possible to prevent the blackening of the light emission section 2.

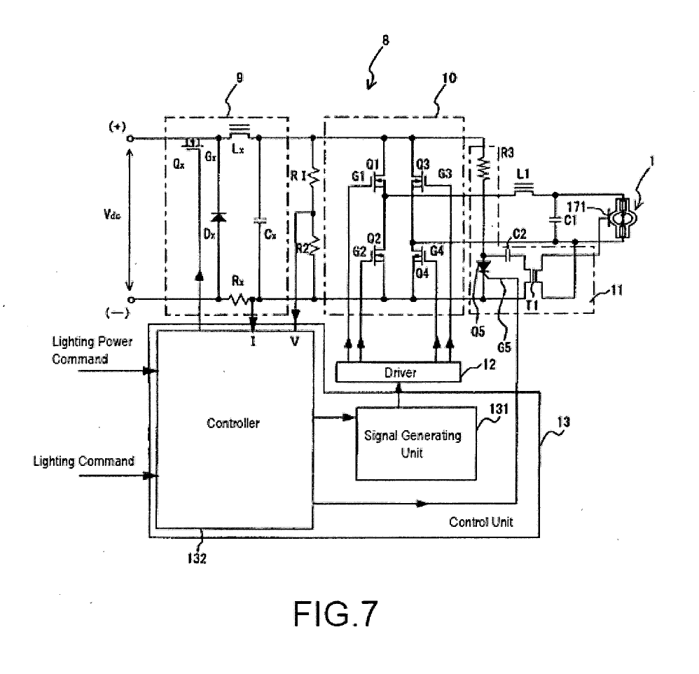

FIG. 7 shows a configuration example of a lighting apparatus to which the extra-high pressure mercury lamp shown as the first and second embodiments, is applied. As shown in the figure, the lighting device 8 is made up of a step down chopper circuit 9 to which direct current voltage is supplied; a full bridge type inverter circuit 10 (hereinafter referred to as a full bridge circuit), which is connected to an output side of the step down chopper circuit 9, and converts direct current voltage into alternating current voltage, to supply it to the extra-high pressure mercury lamp 1; a coil L1 connected in series to the extra-high pressure mercury lamp 1; a capacitor C1; a starter circuit 11; a driver 12, which drives switching elements Q1-Q4 of the full bridge circuit 10, and a control unit 13. The control unit 13 is made up of a processing unit such as a microprocessor.

The control unit 13 is made up of a drive signal generating unit 131 and a controller 132. The drive signal generating part 131 generates a drive signal in order for driving the switching elements Q1-Q4 of the full bridge circuit 10. The controller 132 controls a lighting operation of the extra-high pressure mercury lamp 1, and has a function for driving a switching element Qx of the step down chopper circuit 9 at a set duty ratio, according to a lighting power command from the outside. Moreover, the controller 132 obtains lamp current I and lamp current V from both end voltage of a current detection resistor Rx and voltage detected by voltage detection resistors R1 and R2 to calculate lamp power, and controls a duty ratio of the switching circuit Qx of the step down chopper circuit 9 so that this electric power may be in agreement with electric power, which is commanded by the lighting power command. The drive signal generating part 131 generates the drive signal for driving the switching elements Q1-Q4, and transmits it to the driver 12. The full bridge circuit 10 performs a polarity reversal operation according to the drive signal from the driver 12.

Next, description of an operation of the lighting device 14, will be given below, referring to FIG. 7. First, when a lighting command is given to the controller 132, while the electric power supply to the extra-high pressure mercury lamp 1 is started, the controller 132 generates a start-up circuit drive signal so that the starter circuit 11 is triggered and the extra-high pressure mercury lamp 1 turns on. Next, when the extra-high pressure mercury lamp 1 is lighted, the controller 132 calculates the lighting electric power based on the voltage value V, which is detected by the dividing resistors R1 and R2 and the current value I detected by the resistor Rx. Next, the controller 132 controls the switching element Qx of the step down chopper circuit 9, based on the electric power value, which is commanded by the lighting electric power command signal and the above calculated electric power value, thereby controlling the lighting electric power. Namely, the switching element Qx of the step down chopper circuit 9 is changed according to the duty ratio of the gate signal Gx, wherein the gate signal Gx is controlled according to the lighting power command from the outside, so that the duty ratio of the switching element Qx is increased when the electric power is raised, and the duty ratio is lowered when the electric power is reduced, whereby the electric power may become the electric power value that is in agreement with the inputted lighting power command.

For specifically, when a steady lighting mode is commanded by the lighting power command, the controller 132 controls the duty ratio of the switching element Qx of the step down chopper circuit 9 so as to output electric power that is 70% or more of the rated power, and when a low electric power lighting mode is commanded by the lighting power command, the controller 132 controls the duty ratio of the switching element Qx of the step down chopper circuit 9 to output electric power that is 20% to 75% of the rated power. The reasons that the electric power value commanded in the low electric power lighting mode is set so as to fall within a range of 20% to 75% of the rated power are that if it is 20% or less of the rated power, the extra-high pressure mercury lamp 1 is turned off and that if the electric power is set to 75% or less of the rated power, the electric power supplied to the extra-high pressure mercury lamp 1 at the time of the low electric power lighting mode can be saved.

Next, description of Experiments 1 and 2 regarding a comparison between multiple extra-high pressure mercury lamps according to the present invention, according to a comparative example 1, and according to a comparative example 2 will be given below.

### Experiment 1

In the Experiment 1, ten extra-high pressure mercury lamps shown in FIG. 1, were respectively produced for the present invention, the comparative example 1, and the comparative example 2. The extra-high pressure mercury lamps according to the present invention, the comparative example 1, and the comparative example 2, are different from one another in that the structure of the temperature maintaining portions are different from one another, yet the other structure elements are the same as one another.

The specifications are set forth below.

(1) Example of the present invention: According to the above-mentioned steps 1-4, temperature maintaining portions were produced, in which main ingredient was Al₂O₃ and the temperature maintaining portions contain MgO, SiO₂, and Na₂O with a composition ratio (Al₂O₃:MgO:SiO₂:Na₂O=70:10:5:15). The thickness of a film was 1 mm. (2) Comparative Example 1: Temperature maintaining portions made of only SiO₂, and the thickness was approximately 1 mm. (3) Comparative Example 2: No temperature maintaining portion was provided.

The experimental conditions are set forth below. (1) Rated power of the extra-high pressure mercury lamps was 230 W. (2) The relation between power supplied to an extra-high pressure mercury lamp and the amount of cooling air is set forth below.

Condition 1: The amount of cooling air in case where supplied electric power was 230 W was set as 100 (relative value).

Condition 2: The amount of cooling air in case where supplied electric power was 115 W, was set as 70 (relative value).

Condition 3: The amount of cooling air in case where supplied electric power was 57 W, was set as 50 (relative value).

(3) In each of the above conditions, ten extra-high pressure mercury lamps according to the present invention, ten extra-high pressure mercury lamps of the comparative example 1, and ten extra-high pressure mercury lamps to the comparative examples 2 were lighted for 3 hours. Then, existence of blackening of light emission sections was visually judged.

Table 1 shows a result of Experiment 1.

TABLE 1

| Experiment Conditions | | | | | |
|---|---|---|---|---|---|
| Power | Amount of air | Power | Amount of air | Power | Amount of air |
| (W) | (Relative value) | (W) | (Relative value) | (W) | (Relative value) |
| 230 | 100 | 115 | 70 | 57 | 50 |

| | | | |
|---|---|---|---|
| The Present Invention | 0 | 0 | 0 |
| Comparative Example 1 | 0 | 2 | 3 |
| Comparative Example 2 | 0 | 6 | 10 |

As shown in Table 1, in each of the ten extra-high pressure mercury lamps according to the present invention, no blackening occurred, even if the lamps were changed from a steady lighting mode, in which the rated power of 230 W was supplied to the lamp, to a low electric power lighting mode, in which electric power of 57 W was supplied to the lamp. On the other hand, blacking of light emission sections occurred in three of the ten extra-high pressure mercury lamps according to the comparative example 1, when each of the lamps was changed from a steady sate lighting mode, in which the rated power of 230 W was supplied to the lamps, to a low electric power lighting mode, in which electric power of 57 W was supplied to the lamp. Moreover, in all of the ten extra-high pressure mercury lamps according to a comparative example 2, blackening of the light emission sections occurred, when each of the lamps was changed from a steady lighting mode, in which the rated power of 230 W was supplied to the lamp, to a low electric power lighting mode, in which electric power of 57 W was supplied to the lamp.

### Experiment 2

In Experiment 2, ten extra-high pressure mercury lamps of each of the examples according to the present invention, the comparative example 1, and the comparative example 2, were produced according to the structure shown in FIG. 1. The experiments were conducted, in which the relation between the electric power supplied to the extra-high pressure mercury lamps and the amount of cooling air was changed under conditions set forth below.

The experimental conditions are set forth below.

(1) The rated power of the extra-high pressure mercury lamp was 230 W. (2) The relation between the supplied electric power to extra-high pressure mercury lamps and the amount of cooling air was set forth below.

Condition 1: The amount of cooling air in case where supplied electric power was 230 W is set as 100 (relative value).

Condition 2: The amount of cooling air in case where supplied electric power was 115 W was set as 50 (relative value).

Condition 3: The amount of cooling air in case where supplied electric power was 57 W was set as 30 (relative value).

(3) In each of the examples according to the present invention, the comparative example 1 and the comparative example 2, the ten extra-high pressure mercury lamps were lighted for 3 hours, and then existence of blackening of light emission sections was visually judged.

Table 2 shows a result of Experiment 2.

TABLE 2

| Experiment Conditions | | | | | |
|---|---|---|---|---|---|
| Power | Amount of air | Power | Amount of air | Power | Amount of air |
| (W) | (Relative value) | (W) | (Relative value) | (W) | (Relative value) |
| 230 | 70 | 115 | 50 | 57 | 30 |

| | | | |
|---|---|---|---|
| The Present Invention | 0 | 0 | 0 |
| Comparative Example 1 | 3 | 1 | 0 |
| Comparative Example 2 | 0 | 5 | 7 |

As shown in Table 2, in the ten extra-high pressure mercury lamps according to the present invention, no blackening of light emission sections occurred, in each of which, even if the lamp was changed from a steady lighting mode, in which the rated power of 230 W was supplied to the lamp, to a low electric power lighting mode, in which electric power of 57 W was supplied to the lamp. On the other hand, in three of the ten extra-high pressure mercury lamps according to the comparative example 1, blacking of light emission sections occurred when the rated power of 230 W was supplied to the lamp. Since the amount of cooling air was reduced compared with the experiment 1, the light emission section reached too high a temperature, which may be the cause of the blackening. Moreover, in seven of the ten extra-high pressure mercury lamps according to the comparative example 2, blackening of light emission sections occurred, in each of which cases, the lamp was changed from a steady lighting mode, in which the rated power of 230 W was supplied to the lamp, to a low electric power lighting mode, in which electric power of 57 W was supplied to the lamp. It was confirmed that the blackening of the light emission sections could not be prevented even if the amount of cooling air was reduced.

The preceding description has been presented only to illustrate and describe exemplary embodiments of the present extra-high pressure mercury lamp and the present method of manufacturing extra-high pressure mercury lamp. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. An extra-high pressure mercury lamp, comprising:
a light emission section, a sealing portion continuously formed from the light emission section and a temperature maintaining portion;
the temperature maintaining portion is provided in a vicinity of a boundary between the sealing portion and the light emission section in an outer circumference direction of the lamp;
wherein, during a steady lighting mode, a gap is formed between the temperature maintaining portion and the light emission section to separate the temperature maintaining portion from the light emission section; and
during a low electric power lighting mode, the temperature maintaining portion comes in contact with the light emission section.

2. The extra-high pressure mercury lamp according to claim 1, the temperature maintaining portion is a film that is in a thickness of 0.2-1 mm.

3. The extra-high pressure mercury lamp according to claim 1, the temperature maintaining portion is cylindrical.

4. The extra-high pressure mercury lamp according to claim 1, a thermal expansion coefficient of the temperature maintaining portion is 1×10⁻⁶/K or more.

5. A method for manufacturing the extra-high pressure mercury lamp according to claim 1, comprising:
applying and drying a gap formation medium in the vicinity of the boundary between the light emission section and the sealing portion;
applying and drying a temperature maintaining portion formation medium on the gap formation medium;
primary drying the gap formation medium and the temperature maintaining portion formation medium to remove a solvent contained in the gap formation medium and the temperature maintaining portion formation medium; and
secondary drying the gap formation medium and the temperature maintaining portion formation medium, to remove the gap formation medium and to form the temperature maintaining portion.

6. The method for manufacturing an extra-high pressure mercury lamp according to claim 5, wherein the gap formation medium is a gelatinous substance obtained by mixing C₁₇H₃₅COOH (stearic acid) with graphite powder.

7. The method for manufacturing an extra-high pressure mercury lamp according to claim 5, wherein the temperature maintaining portion formation medium is a suspension obtained by mixing powders of alumina (Al₂O₃), magnesium oxide (MgO), silica (SiO₂), and sodium oxide (Na₂O) with water.

8. The method for manufacturing an extra-high pressure mercury lamp according to claim 5, wherein the temperature maintaining portion formation medium is a metal alkoxide polymer of alumina (Al₂O₃), magnesium oxide (MgO), silica (SiO₂), and sodium oxide (Na₂O).

9. The extra-high pressure mercury lamp according to claim 1, the light emission section encloses 0.15 mg/mm³ or more of mercury.

10. The extra-high pressure mercury lamp according to claim 1, a steady lighting mode and a low electric power lighting mode can be switched.

11. The extra-high pressure mercury lamp according to claim 1, the lamp is driven during the low electric power lighting mode at an electric power in a range of 20% to 75% of rated consumed power of the steady lighting mode.

12. The extra-high pressure mercury lamp according to claim 1, the temperature maintaining portion is made of a material that has a thermal expansion coefficient that is greater than a material that forms the light emission section.

13. The extra-high pressure mercury lamp according to claim 1, the temperature maintaining portion absorbs a light emitted from the light emission section and maintains a temperature of the light emission section.
